(19) United States
(12) Patent Application Publication
(10) Pub. No.: US 2024/0009748 A1
(43) Pub. Date: Jan. 11, 2024

(54) ROBOT WELDING SYSTEM, ROBOT OPERATION TERMINAL, AND WELDING ROBOT TEACHING PROGRAM

(71) Applicant: FANUC CORPORATION, Yamanashi (JP)

(72) Inventor: Shun KOTERA, Yamanashi (JP)

(73) Assignee: FANUC CORPORATION, Yamanashi (JP)

(21) Appl. No.: 18/040,412

(22) PCT Filed: Aug. 23, 2021
(86) PCT No.: PCT/JP2021/030812

§ 371 Date: Feb. 2, 2023

(30) Foreign Application Priority Data
Aug. 26, 2020 (JP) 2020-142559

(51) Int. Cl. B23K 9/095; B25J 9/16

(52) U.S. Cl. CPC B23K 9/0953; B25J 9/163; B25J 9/1664

(57) ABSTRACT

The purpose of the present invention is to provide a system that can easily teach a welding robot. A robot welding system according to one aspect of the present disclosure comprises: a robot; a robot controller; a welding torch; and a robot operation terminal including an image capturing device, a display device, and a terminal controller. The terminal controller includes a teaching accepting unit that accepts an input of teaching information for the robot. The robot controller or the terminal controller includes: an attitude calculation unit that calculates an attitude of the welding torch, on the basis of basic information about the robot, a processing program and the teaching information input to the teaching accepting unit; an AR display unit that displays motion information about the welding torch corresponding to an image captured by the image capturing device, on the display device in a superimposed manner over the image captured by the image capturing device; and a program recording unit that causes the robot controller to correct or newly store the processing program, on the basis of the teaching information.

### TECHNICAL FIELD

The present invention pertains to a robot welding system, a robot operation terminal, and a welding robot teaching program.

### BACKGROUND ART

In robot welding in which a robot causes a welding gun or a welding torch to move and thereby perform welding work, work to teach motion to the robot is typically required. In work to teach a robot, it is necessary to cause the robot to move carefully such that the robot or a welding gun or welding torch held by the robot does not come into contact with a nearby apparatus or a target object.

As an example, in a case of teaching an arc welding robot, it is desirable to cause a welding wire to protrude from the tip end of a welding torch by the same length as when welding is actually performed, and teach the robot while confirming a positional relationship between the welding wire and a target object. However, in a case of performing teaching while actually causing a robot to move, there are risks of mistakenly causing the welding wire to come into contact with the target object and causing the welding wire to bend. Because it is not possible to perform accurate teaching in a state where the welding wire is bent, it is necessary to return the welding wire to an appropriate state in such a case. Accordingly, teaching work requires an operator to carefully operate the robot such that the welding wire does not come into contact with a target object as much as possible, and requires the operator to have a level of proficiency.

As a technique for teaching a robot, a technique that configures, on a computer, three-dimensional models for a robot and a nearby apparatus and simulates motion by the robot to thereby prevent trouble in which the robot actually comes into contact with the nearby apparatus has been proposed (for example, refer to Patent Document 1).
Patent Document 1: Japanese Unexamined Patent Application, Publication No. 2003-165079

### DISCLOSURE OF THE INTENTION

### Problems to be Solved by the Invention

In a case of using a simulation to teach motion to a welding robot, precise three-dimensional models for nearby apparatuses and target objects are necessary, and preparing data therefor is complicated. Accordingly, a system that enables a welding robot to be easily taught is desired.

An object of the present invention is to provide a system that enables a welding robot to be easily taught.

### Means for Solving the Problems

A robot welding system according to one aspect of the present disclosure includes: a robot; a robot controller configured to control the robot in accordance with a processing program; a welding torch that is attached to a tip end of the robot and is configured to perform arc welding of a target object; and a robot operation terminal that has an image capturing device, a display device, and a terminal controller, and is configured to communicate with the robot controller, in which the terminal controller has a teaching accepting unit configured to accept input of teaching information for the robot, the robot controller or the terminal controller has an attitude calculation unit configured to calculate an attitude for the welding torch based on basic information regarding the robot stored by the robot controller, the processing program, and the teaching information inputted to the teaching accepting unit, an AR display unit configured to cause the display device to super imposingly display motion information for the welding torch corresponding to an image captured by the image capturing device on the image captured by the image capturing device, and a program recording unit configured to, based on the teaching information, cause the robot controller to correct the processing program or newly store the processing program.

A robot operation terminal according to another aspect of the present disclosure, in a robot welding system for arc welding a target object using a welding torch attached to a tip end of a robot controlled by a robot controller in accordance with a processing program, teaches the robot, the robot operation terminal including: an image capturing device, a display device, and a terminal controller, in which the terminal controller has a teaching accepting unit configured to accept input of teaching information for the robot, an attitude calculation unit configured to calculate an attitude for the welding torch based on basic information regarding the robot stored by the robot controller, the processing program, and the teaching information inputted to the teaching accepting unit, an AR display unit configured to cause the display device to superimposingly display motion information for the welding torch corresponding to an image captured by the image capturing device on the image captured by the image capturing device, and a program recording unit configured to, based on the teaching information, cause the robot controller to correct the processing program or newly store the processing program.

A welding robot teaching program according to another aspect of the present disclosure, in a robot welding system for arc welding a target object using a welding torch attached to a tip end of a robot controlled by a robot controller in accordance with a processing program, enables a portable terminal having an image capturing device, a display device, and a terminal controller to teach the robot, the welding robot teaching program including: a teaching control unit configured to accept input of teaching information for the robot; an attitude calculation control unit configured to calculate an attitude for the welding torch based on basic information regarding the robot stored by the robot controller, the processing program, and teaching information accepted by the teaching control unit, an AR display control unit configured to cause the display device to superimposingly display motion information for the welding torch corresponding to an image captured by the image capturing device on the image captured by the image capturing device, and a program recording control unit configured to, based on the teaching information, cause the robot controller to correct the processing program or newly store the processing program.

### Effects of the Invention

By virtue of the robot welding system, robot operation terminal, and welding robot teaching program according to the present disclosure, it is possible to easily teach a welding robot.

### BRIEF DESCRIPTION OF THE DRAWINGS

FIG. 1 is a schematic view that illustrates a configuration of a robot welding system according to one embodiment of the present invention;

FIG. 2 is a block view that illustrates a configuration pertaining to control of the robot welding system in FIG. 1;

FIG. 3 is a view for exemplifying a display image by a display device belonging to a robot operation terminal in the robot welding system in FIG. 1;

FIG. 4 is a view for exemplifying a display image that differs to that in FIG. 3 and is by a display device belonging to the robot operation terminal in the robot welding system in FIG. 1;

FIG. 5 is a view for exemplifying a display image that differs to those in FIGS. 3 and 4 and is by a display device belonging to the robot operation terminal in the robot welding system in FIG. 1;

FIG. 6 is a view for exemplifying a display image that differs to those in FIGS. 3 to 5 and is by a display device belonging to the robot operation terminal in the robot welding system in FIG. 1; and

FIG. 7 is a view for exemplifying a display image that differs to those in FIGS. 3 to 6 and is by a display device belonging to the robot operation terminal in the robot welding system in FIG. 1.

### PREFERRED MODE FOR CARRYING OUT THE INVENTION

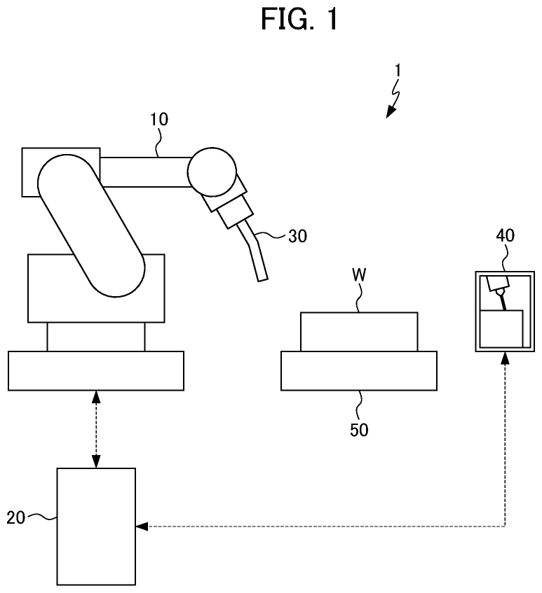

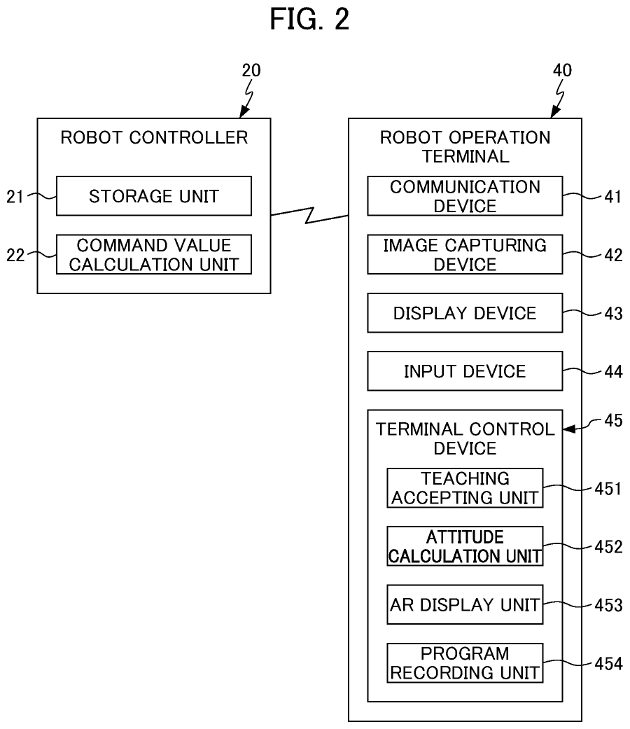

Description is given below regarding an embodiment according to the present invention, with reference to the drawings. FIG. 1 is a schematic view that illustrates a configuration of a robot welding system 1 according to one embodiment of the present disclosure. FIG. 2 is a block view that illustrates a configuration pertaining to control of the robot welding system 1.

The robot welding system 1 is provided with a robot 10, a robot controller 20 that controls the robot 10 in accordance with a processing program, a welding torch 30 that is attached to a tip end of the robot 10, a robot operation terminal 40 that communicates with the robot controller 20, and a jig 50 that holds a target object W to be welded. The robot welding system 1 uses the welding torch 30 attached to the tip end of the robot 10, which is controlled by the robot controller 20 in accordance with the processing program, to perform arc welding for the target object W.

The robot 10 has a plurality of drive shafts, and can position the welding torch 30 in an arbitrarily-defined attitude (spatial position and orientation). The robot 10 may be a scalar robot, a parallel-link robot, a Cartesian coordinate robot, etc., but it is desirable to use a vertical articulated robot which has versatility and for which the spatial position and orientation of the welding torch 30 can be defined with comparative freedom.

The robot controller 20 is provided with a storage unit 21 that stores a processing program and basic information such as machine configuration information for the robot 10, and a command value calculation unit 22 that calculates a command value for designating an angular position for each drive shaft such that the robot 10 can be positioned at an attitude designated by the processing program. The robot controller 20 defines an attitude for the robot 10 in a predetermined processing coordinate system, specifically a world coordinate system in which the center of an installation base for the robot 10 is regarded as the origin or a tool coordinate system in which a tool tip end position (the tip end of a protruding welding wire) is regarded as the origin, or in a user coordinate system in which a position that is arbitrarily designated by a user is regarded as the origin.

The robot controller 20 can be realized by introducing an appropriate control program into a computer device that has a CPU, a memory, communication interface, etc. The components in the robot controller 20 may be realized by respectively independent hardware, or may be realized by a single item of hardware. In other words, the components in the robot controller 20 result from classifying functionality for the robot controller 20, and there is no need to be able to clearly separate the mechanical structure and program structure thereof. The robot controller 20 may also have additional components that realize other functions.

Something that performs gas shielded welding using a consumable electrode, such as carbon-dioxide-gas arc welding, MIG welding, or MAG welding, for example is in particular desirably used as the welding torch 30. Note that, a welding torch that uses a non-consumable electrode such as with TIG welding, for example, may be used, and usage of a torch for performing another type of welding is also not excluded.

The robot operation terminal 40 is itself one embodiment of a robot operation terminal 40 according to the present disclosure. The robot operation terminal 40 in the present embodiment is provided with a communication device 41, an image capturing device 42, a display device 43, an input device 44, and a terminal controller 45.

The robot operation terminal 40 can be realized by installing an appropriate welding robot teaching program onto a portable terminal such as a tablet PC, a laptop PC, or a smartphone, for example. The welding robot teaching program for realizing the robot operation terminal 40 is itself one embodiment for a welding robot teaching program according to the present invention. As it clear from this configuration, the communication device 41 controls communication with the robot controller 20 via a wired LAN, a wireless LAN, a public communication network, etc. The image capturing device 42 is a camera that has an image capturing element. The display device 43 is an image display device such as a liquid-crystal display panel or an organic EL display panel. The input device 44 is a keyboard, a touch sensor, etc. It is desirable for the display device 43 and the input device 44 to be an integrally formed touch panel. In addition, the terminal controller 45 has a CPU, a memory, etc., and executes a welding robot teaching program to thereby control the communication device 41, the image capturing device 42, the display device 43, and the input device 44.

The terminal controller 45 has a teaching accepting unit 451, an attitude calculation unit 452, an AR display unit 453, and a program recording unit 454. These components result from classifying functionality for the terminal controller 45, and there is no need to clearly separate them in the program structure thereof. The terminal controller 45 may also have additional components that realize other functions.

The teaching accepting unit 451 accepts input, made using the input device 44, of teaching information that includes position information regarding a teaching point (for example, a position for a reference point for the welding torch 30, a position for a point to be processed, etc.) and information for instructing an orientation for the welding torch 30, the teaching point being designated by a user as a position representing an attitude for the welding torch 30. As a concrete example, the teaching accepting unit 451 can be configured such that it is possible to specify coordinates for a teaching point by causing an image resulting from superimposing a grid representing coordinates on an image captured by the image capturing device 42 of the periphery around a target object to be displayed on the display device 43 and the user using the input device 44 to select a position on the display device 43.

It is desirable for the teaching accepting unit 451 to cause the display device 43 to display an image that indicates axial directions for a processing coordinate system for performing arc welding. As a result, the user is more likely to understand an attitude for the robot 10 and details regarding teaching motion that the user themself is to perform.

The teaching accepting unit 451 may be configured to cause the display device 43 to display a pointer that indicates coordinates for a candidate position for a teaching point, and to accept an operation for causing the pointer to move on a screen and an operation for establishing, as a teaching point, a position for the pointer displayed on the screen.

On the basis of the basic information for the robot 10 and the processing program which are stored in the storage unit 21 in the robot controller 20 as well as teaching information inputted to the teaching accepting unit 451, the attitude calculation unit 452 calculates an attitude for the robot 10 and consequently an attitude (spatial position and orientation) for the welding torch 30. The attitude calculation unit 452 is configured to be able to calculate an attitude for the welding torch 30 based on only the basic information and the processing program, if necessary.

It is desirable for the attitude calculation unit 452 to be able to successively calculate an attitude for the welding torch 30 for each time in accordance with the processing program stored by the robot controller 20. By the attitude calculation unit 452 successively calculating an attitude for the welding torch 30 for each time, it is possible to confirm a track for movement by the welding torch 30 in accordance with the processing program.

The AR display unit 453 causes the display device 43 to superimposingly display (AR display) motion information regarding the welding torch 30 and corresponding to an image captured by the image capturing device 42 on the image captured by the image capturing device 42. It is desirable for motion information subjected to an AR display by the display device 43 to include at least one selected from a model of the tip end of the welding torch 30, a reference point for the welding torch 30, a point to be processed by the welding torch 30, a direction of movement of the reference point for the welding torch 30 or the point to be processed by the welding torch 30, an angle between the welding torch 30 and the target object W, axial directions for a coordinate system in which the robot 10 moves, and a length by which a welding wire protrudes from the welding torch 30. In addition, the motion information may include a speed for the welding torch 30 or a point to be processed or an interval between teaching points, or may include at least one selected from a welding wire feeding speed command value, a welding current command value, a welding voltage command value, and a command value for welding waveform control.

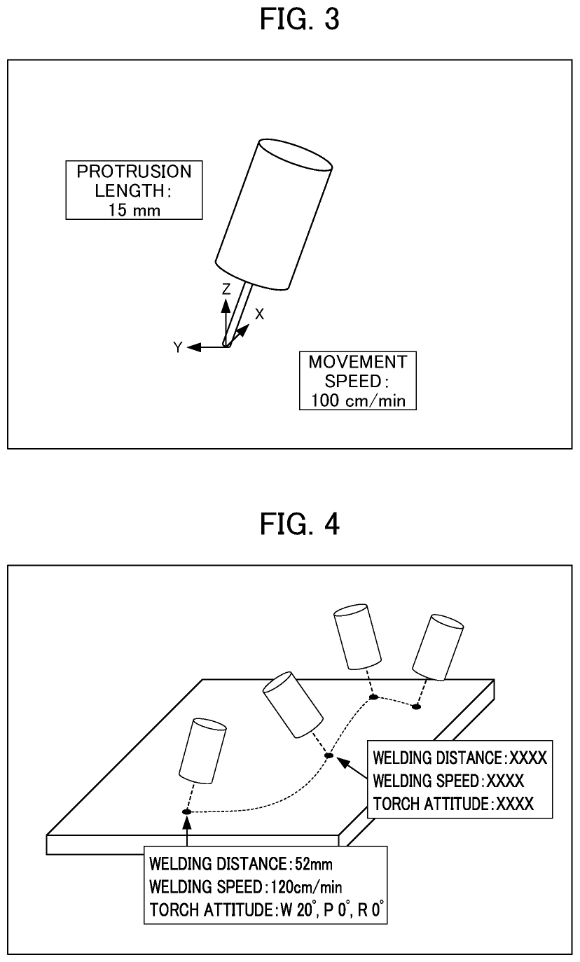

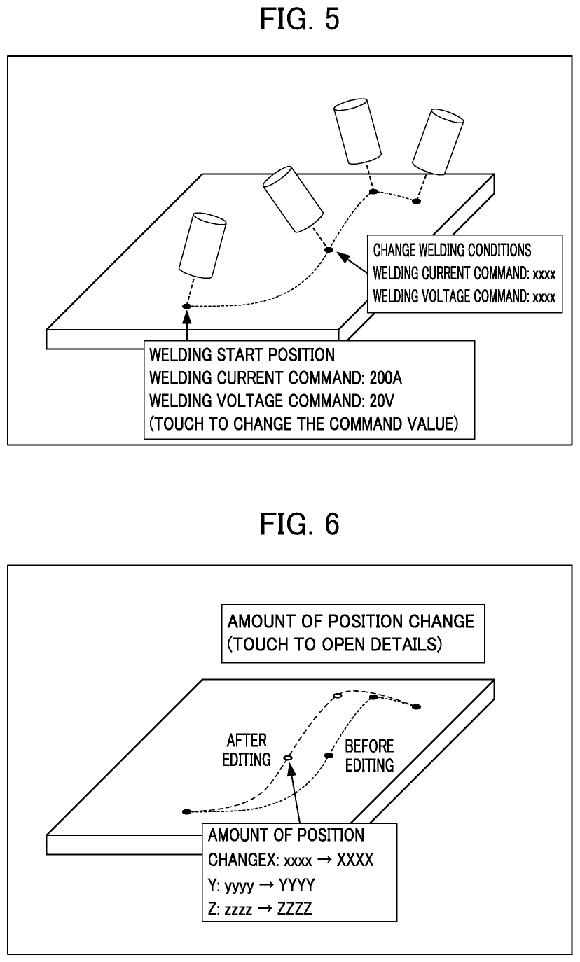

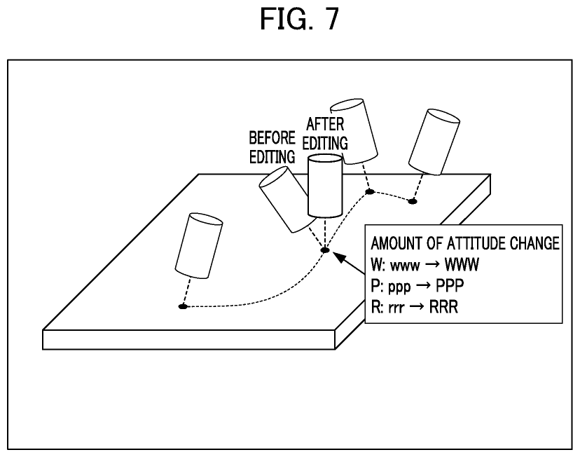

As a concrete example, in FIG. 3, axial directions for a processing coordinate system in which the robot 10 moves and a length by which a welding wire protrudes are subjected to an AR display by the display device 43. In this manner, based on respective shaft angle information for the robot 10 or setting information regarding a processing coordinate system, the AR display unit 453 specifies an attitude for the welding torch 30 in an image captured by the image capturing device 42 and performs an AR display for an image indicating axial directions for the processing coordinate system, whereby a user can easily understand a direction of movement by the welding torch 30 in response to an input with respect to the teaching accepting unit 451. In addition, the AR display unit 453 calculates a length by which the welding wire protrudes based on an image captured by the image capturing device 42 and performs an AR display for the calculated length by which the welding wire protrudes, whereby the user can easily determine an appropriateness for welding.

As another example, in FIG. 4, models of the tip ends of a plurality of welding torches 30 indicating the attitude, calculated by the attitude calculation unit 452, of the welding torch 30 at each teaching point in a processing program, a plurality of markers indicating positions for points to be processed at respective teaching points, and a line indicating a track for points to be processed between respective teaching points are subjected to an AR display by being superimposed on an image of a workpiece W captured by the image capturing device 42. In this manner, the AR display unit 453 collectively performs an AR display for motion information for the welding torch 30 at a plurality of teaching points, whereby a user can easily confirm the appropriateness of the processing program. In addition, by performing an AR display for a model of the tip end of the welding torch 30, it becomes possible to teach the robot 10 or correct the processing program after confirming details of the processing program which is stored by the robot controller 20, without actually causing the robot 10 to move.

Furthermore, in FIG. 4, using the AR display unit 453, an AR display is performed for text information regarding welding conditions determined by the robot 10, such as a welding distance, welding speed (speed of movement from one point to be processed to the next point to be processed), and the attitude of the welding torch 30. In addition, display of these items of text information may also serve as an interface for the teaching accepting unit 451. Specifically, it may be that a user touches text displayed by the AR display unit 453, whereby there is a display for the teaching accepting unit 451 by which the user can correct a touched item. As a result, fine adjustment of the processing program becomes easy. In addition, configuration may be such that this kind of text information can be hidden in accordance with a selection by the user.

In addition, as illustrated in FIG. 4, text information regarding welding conditions determined regardless of the robot 10, such as a welding current command value or a welding voltage command value are subjected to an AR display and superimposed on the same captured image as in FIG. 4. In addition, display of such welding conditions may also serve as an interface for the teaching accepting unit 451. In addition, a function for causing change of welding conditions from the start to the end of welding to be graphed and displayed may be provided on such a display screen.

In addition, as illustrated in FIG. 6, the AR display unit 453 may display both of motion information before the program recording unit 454 corrects the processing program and motion information after the program recording unit 454 corrects the processing program, or the difference therebetween. In this manner, by displaying change in a welding state due to a correction to a processing program, a user can easily confirm the appropriateness of the correction. It is desirable for the AR display unit 453 to use color, line types, etc. to distinguishably display a track in accordance with a processing program before a correction and a track in accordance with a corrected processing program.

In addition, in a case where the attitude of the welding torch 30 changes due to a correction to a processing program, it may be that an AR display is performed by superimposing a model for the tip end of the welding torch 30 in accordance with the processing program before the correction and a model for the tip end of the welding torch 30 in accordance with the corrected processing program. As a result, it is possible to easily confirm the effect of correcting the processing program.

It is desirable for the AR display unit 453 to be able to, for each time in accordance with the processing program, change a display for, for example, a model of the welding torch 30. In other words, it is desirable for the AR display unit 453 to be able to perform a moving-image display for motion by the welding torch 30. By performing a moving-image display for motion by the welding torch 30, a user can easily confirm the appropriateness of the processing program. In addition, the AR display unit 453 may display a track superimposed on a reference point for the welding torch 30 at each time, points to be processed by the welding torch 30, etc. As a result, a user can easily understand motion by the welding torch 30 and motion for welding by the welding torch 30.

The program recording unit 454 creates a processing program based on teaching information, and corrects a processing program stored in the storage unit 21 in the robot controller 20 or causes the storage unit 21 to newly store the processing program. In a case of correcting a processing program stored in the storage unit 21 to thereby generate a new processing program, the program recording unit 454 may keep the processing program for before the correction.

The jig 50 immovably holds the target object W in the processing coordinate system. The jig 50 may have, for example, a plurality of markers for accurately grasping the attitude of the jig 50, and consequently the target object W, in an image captured by the image capturing device 42 in the robot operation terminal 40.

Because a user uses the robot operation terminal 40 to define a viewpoint, the robot welding system 1 enables setting of a viewpoint to be intuitively performed in comparison to an operation in which a mouse, etc. is used to define a viewpoint in a complete simulation environment (an environment in which various elements such as a robot model, a torch model, and a model for a welding target object are displayed on a PC screen using dedicated software), as in the past. Accordingly, the robot welding system 1 enables motion by the welding torch 30, etc. to be easily confirmed, and enables a processing program to be easily inputted and corrected.

As is clear from the above description, one embodiment of a welding robot teaching program according to the present disclosure has a teaching control unit for realizing the teaching accepting unit 451, an attitude calculation control unit for realizing the attitude calculation unit 452, an AR display unit for realizing the AR display unit 453, and a program recording control unit for realizing the program recording unit 454. A welding robot teaching program according to the present disclosure can be provided after being recorded to a non-transitory recording medium.

Description was given above regarding an embodiment for a robot welding system according to the present disclosure, but the scope for the present disclosure is not limited to the embodiment described above. In addition, effects set forth in the embodiment described above merely list the most suitable effects that arise from the robot welding system according to the present disclosure. Effects due to the robot system welding according to the present disclosure are not limited to those set forth in the embodiment described above.

As an example, in a robot welding system according to the present disclosure, a robot controller may have some or all of the attitude calculation unit, AR display unit, and program recording unit in the terminal controller according to the above-described embodiment. By providing these functions in the robot controller, it is possible to reduce a compute load for the robot operation terminal, and a comparatively cheap robot operation terminal can be used. In other words, in a robot welding system according to the present disclosure, it may be that the terminal controller has the teaching accepting unit and the robot controller or the terminal controller has the attitude calculation unit, the AR display unit, and the program recording unit.

### EXPLANATION OF REFERENCE NUMERALS

1 Robot welding system
10 Robot
20 Robot controller
21 Storage unit
22 Command value generation unit
30 Welding torch
40 Robot operation terminal
41 Communication device
42 Image capturing device
43 Display device
44 Input device
45 Terminal controller
451 Teaching accepting unit
452 Attitude calculation unit
453 AR display unit
454 Program recording unit
50 Jig
W Target object

1. A robot welding system, comprising:
a robot;
a robot controller configured to control the robot in accordance with a processing program;
a welding torch that is attached to a tip end of the robot and is configured to perform arc welding of a target object; and
a robot operation terminal that has an image capturing device, a display device, and a terminal controller, and is configured to communicate with the robot controller, wherein
the terminal controller has a teaching accepting unit configured to accept input of teaching information for the robot,
the robot controller or the terminal controller has
an attitude calculation unit configured to calculate an attitude for the welding torch based on basic information regarding the robot stored by the robot controller, the processing program, and the teaching information inputted to the teaching accepting unit,
an AR display unit configured to cause the display device to superimposingly display motion information for the welding torch corresponding to an image captured by the image capturing device on the image captured by the image capturing device, and
a program recording unit configured to, based on the teaching information, cause the robot controller to correct the processing program or newly store the processing program.

2. The robot welding system according to claim 1, wherein
the motion information includes at least one selected from a model for a tip end of the welding torch, a reference point for the welding torch, a point to be processed by the welding torch, a direction of movement for either the reference point for the welding torch or the point to be processed by the welding torch, an angle between the welding torch and the target object, an axial direction for a coordinate system in which the robot moves, and a length by which a welding wire protrudes from the welding torch.

3. The robot welding system according to claim 1, wherein
the motion information includes a speed for the welding torch or a point to be processed by the welding torch, or an interval between teaching points that represent an attitude for the welding torch and is specified by the teaching information.

4. The robot welding system according to claim 1, wherein
the motion information includes at least one selected from a feeding speed command value for a welding wire, a welding current command value, a welding voltage command value, and a command value for welding waveform control.

5. The robot welding system according to claim 1, wherein
the AR display unit displays both of, or a difference between, the motion information before the processing program is corrected by the program recording unit and the motion information after the processing program is corrected by the program recording unit.

6. The robot welding system according to claim 1, wherein
the attitude calculation unit is capable of successively calculating an attitude for the welding torch at each time in accordance with the processing program, and
the AR display unit causes display of at least one selected from a model for a tip end of the welding torch, a reference point for the welding torch, and a point to be processed by the welding torch to change at each time in accordance with the processing program.

7. A robot operation terminal that, in a robot welding system for arc welding a target object using a welding torch attached to a tip end of a robot controlled by a robot controller in accordance with a processing program, teaches the robot, the robot operation terminal comprising an image capturing device, a display device, and a terminal controller, wherein
the terminal controller has:
a teaching accepting unit configured to accept input of teaching information for the robot;
an attitude calculation unit configured to calculate an attitude for the welding torch based on basic information regarding the robot stored by the robot controller, the processing program, and the teaching information inputted to the teaching accepting unit;
an AR display unit configured to cause the display device to superimposingly display motion information for the welding torch corresponding to an image captured by the image capturing device on the image captured by the image capturing device; and
a program recording unit configured to, based on the teaching information, cause the robot controller to correct the processing program or newly store the processing program.

8. A non-transitory recording media which non-transitorily records a welding robot teaching program that, in a robot welding system for arc welding a target object using a welding torch attached to a tip end of a robot controlled by a robot controller in accordance with a processing program, enables a portable terminal having an image capturing device, a display device, and a terminal controller to teach the robot, the welding robot teaching program comprising:
a teaching control unit configured to accept input of teaching information for the robot;
an attitude calculation control unit configured to calculate an attitude for the welding torch based on basic information regarding the robot stored by the robot controller, the processing program, and teaching information accepted by the teaching control unit,
an AR display control unit configured to cause the display device to superimposingly display motion information for the welding torch corresponding to an image captured by the image capturing device on the image captured by the image capturing device, and
a program recording control unit configured to, based on the teaching information, cause the robot controller to correct the processing program or newly store the processing program.
